(19) United States
(12) Patent Application Publication
(10) Pub. No.: US 2006/0132864 A1
(43) Pub. Date: Jun. 22, 2006

(54) Image scanning apparatus

(75) Inventors: Sung-Yang Wu, Taipei (TW); Chien-Kuo Kuan, Taipei (TW); Hsi-Yu Chen, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/129,684

(22) Filed: May 13, 2005

(30) Foreign Application Priority Data
Dec. 17, 2004 (TW) 093139515

(51) Int. Cl. H04N 1/04

(52) U.S. Cl. 358/487

(57) ABSTRACT

An image scanning apparatus is employed for scanning a transparent object by using a source light generated from an image display. The image scanning apparatus includes a housing, an image scanning module and a connection member. The image scanning module is disposed within the housing for scanning the object, thereby generating an electrical signal of an image of the object. The connection member is used for hanging the housing on the image display such that the image scanning module receives the source light from the image display. The space for operating the scanning apparatus of the present invention is largely reduced when compared with the conventional transmissive scanner.

### FIELD OF THE INVENTION

The present invention relates to an image scanning apparatus, and more particularly to an image scanning apparatus for performing a transmissive scanning operation by using an image display as a light source.

### BACKGROUND OF THE INVENTION

Conventionally, a transmissive scanner is used for scanning transparent objects such as films or slides (also referred as positives or negatives). Referring to FIG. 1, a schematic view of a conventional transmissive scanner is shown. The transmissive scanner 10 comprises a main body 12 and a reflective plate 14. At least one scanning module 121 and a driving device 123 for moving the scanning module 121 are included within the main body 12. A light source 141 is enclosed with the reflective plate 14. The light emitted by the light source 141 penetrates through the scanned object, i.e. a film or slide, and then enters the scanning module 121. The light is processed by the scanning module 121 to generate corresponding signals.

As known, penetrative light sources are generally classified as three types, as shown in FIGS. 2A, 2B and 2C. Referring to FIG. 2A, a schematic view of a first type penetrative light source is illustrated. The first type is a lateral-projection light source and comprises a light-emitting element 161 and a light-guiding plate 163. The light-emitting element 161 is disposed at one side of the light-guiding plate 163, which afterwards guides the light emitted from the light-emitting element 161 downwards. Referring to FIG. 2B, a schematic view of a second type penetrative light source is illustrated. The second type is a downward-projection light source and comprises a light-emitting element 181 and a reflective plate 183. The light emitted from the light-emitting element 181 is reflected by the reflective plate 183 and then projected downwards. Referring to FIG. 3C, a schematic view of a third type penetrative light source is illustrated. The third type penetrative light source comprises a light-emitting element 201 and a reflective plate 202, which are included in a top cover 200 of the scanner. The light-emitting element 201 and the scanning module 121 are synchronously moved.

The above penetrative light sources, however, occupy a lot of space. In addition, since the penetrative light source is necessary to scan a transparent object, the overall volume of the transmissive scanner is increased and the fabricating cost thereof is not satisfactory.

In view of the above-described disadvantages resulted from the prior art, the applicant has diligently developed an image scanning apparatus according to the present invention through wholehearted experience and research.

### SUMMARY OF THE INVENTION

It is an object of the present invention to provide a transmissive scanning apparatus for scanning a transparent object such as a film or slide by using an image display as a light source.

In accordance with a first aspect of the present invention, there is provided an image scanning apparatus for scanning a transparent object by using a source light generated from an image display. The image scanning apparatus comprises a housing, an image scanning module and a connection member. The image scanning module is disposed within the housing for scanning the object, thereby generating an electrical signal of an image of the object. The connection member can hang the housing on the image display such that the image scanning module receives the source light from the image display.

In an embodiment, the image scanning apparatus further comprises a light diffusing plate arranged between the image display and the object, thereby achieving even illumination of the source light for penetrating through the object.

Preferably, the connection member includes two hook structures.

In accordance with a second aspect of the present invention, there is provided an image scanning system for scanning an object. The image scanning system comprises an image display, a host computer and an image scanning apparatus. The image display generates a source light for scanning the object. The host computer is in communication with the image display. The image scanning apparatus is in communication with the host computer, and comprises a housing, an image scanning module and a connection member. The image scanning module is disposed within the housing for scanning the object, thereby generating an electrical signal of an image of the object. The connection member can hang the housing on the image display such that the image scanning module receives the source light from the image display.

In accordance with a third aspect of the present invention, there is provided an image scanning apparatus for scanning a transparent object by using a source light generated from an image display. The image scanning apparatus comprises a housing, an image scanning module and a control circuit. The image scanning module is disposed within the housing for scanning the object, thereby generating an electrical signal of an image of the object. The control circuit is disposed within the housing for controlling the image scanning module and the image display, characterized in that the image display is controlled to generate the source light by the control circuit.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view of a conventional transmissive scanner;

FIG. 2A is a schematic view of a lateral-projection type penetrative light source according to prior art;

FIG. 2B is a schematic view of a downward-projection type penetrative light source according to prior art;

FIG. 2C is a schematic view of another penetrative light source according to prior art, in which the light-emitting element and the scanning module are synchronously moved;

FIG. 3 is a schematic view of an image scanning apparatus according to a first embodiment of the present invention, which is hung on an image display and in communication with a host computer; and

FIG. 4 is a schematic view of an image scanning apparatus according to a second embodiment of the present invention, which is hung on an image display.

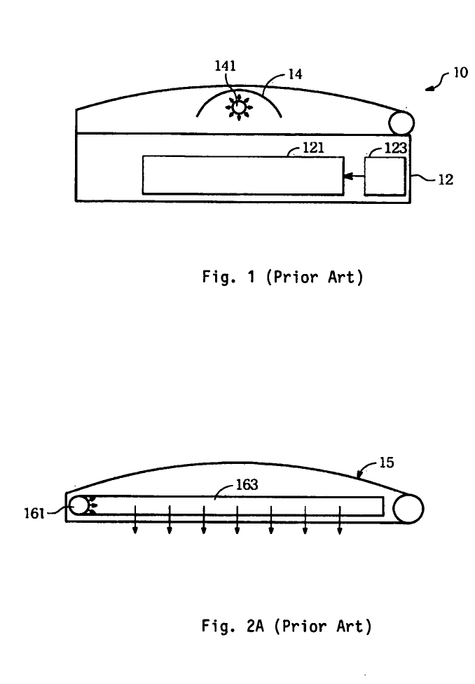

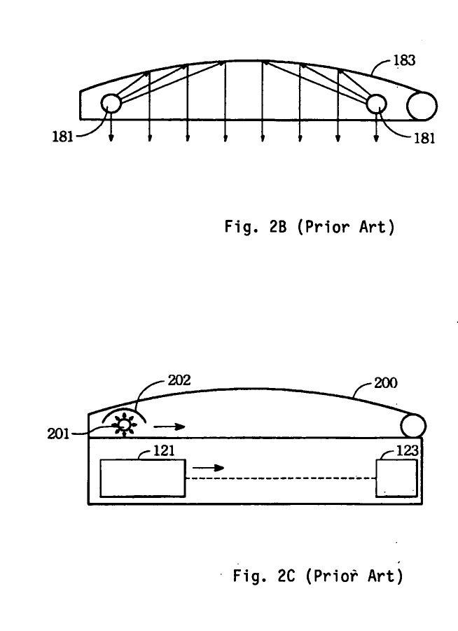

### DETAILED DESCRIPTION OF THE PREFERRED EMBODIMENT

As previously described, a penetrative light source is essential for performing the transmissive scanning operation, but the installation of the penetrative light source increasing the overall volume and cost of the scanner. For overcoming these drawbacks, in accordance with the present invention, the penetrative light source is exempted from the scanning apparatus. Instead, the source light from the image display is directly used for performing the scanning operation.

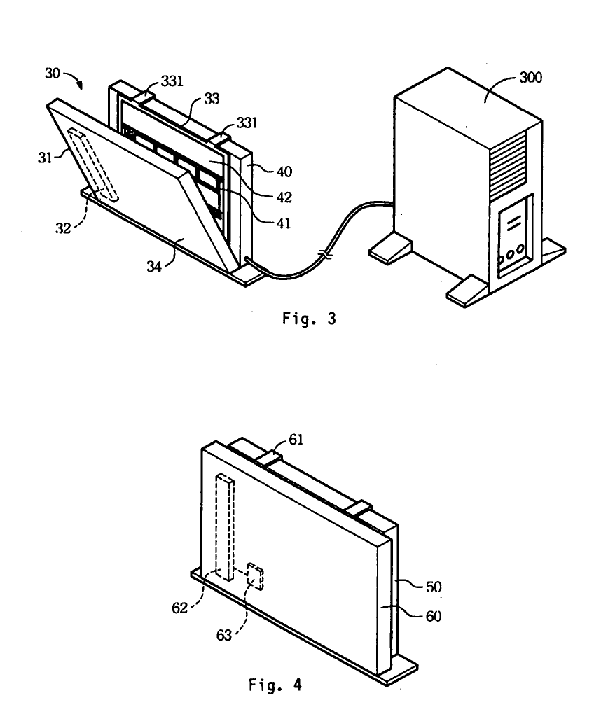

Referring to FIG. 3, a schematic view of an image scanning apparatus according to a first embodiment of the present invention is illustrated. In this embodiment, the object to be scanned is for example a film. The image scanning apparatus 30 of FIG. 3 comprises a housing 31, an image scanning module 32 and a connection member 33. In this embodiment, the connection member 33 includes two hook structures 331. Furthermore, additional components shown in FIG. 3 comprise an image display 40 such as a liquid crystal display, a film holder 41 capable of supporting the film in position, and a host computer 300. Both of the image display 40 and the image scanning apparatus 30 are in communication with the host computer 300.

Via the hook structures 331 of the connection member 33, the image scanning apparatus 30 will be hung on the image display 40. Under this circumstance, the image scanning module 32 of the image scanning apparatus 30 can receive the source light from the image display 40 for scanning the film.

In addition, a light diffusing plate 42 is arranged between the image display 40 and a glass platform (not shown) for placing thereon the object to be scanned, thereby achieving the purpose of even illumination. Therefore, the light received by the image scanning module 32 is evenly distributed. Moreover, the bottom portion 34 of the housing 31 is transparent such that the user can view the information displayed on the image display 40 therevia.

By the way, the locations of the film holder 41 and the light diffusing plate 42 can be varied as required. For example, the film holder 41 can be fixed on the connection member 33, as shown in FIG. 3, or alternatively fixed on the surface of the housing 31 of the image scanning apparatus 30. The light diffusing plate 42 can be disposed on connection member 33, as shown in FIG. 3, or separately arranged.

It is noted that, however, those skilled in the art will readily observe that numerous modifications and alterations of the connection member may be made while retaining the teachings of the invention. For example, the connection member 33 may be a frame having the hook structure and separated from the image scanning apparatus 30, as described in the embodiment of FIG. 3. Alternatively, one or two hook structures may be directly integrated into the periphery of the housing 31 of the image scanning apparatus 30 such that the image scanning apparatus 30 can be hung on the image display 40. Accordingly, the above disclosure should be limited only by the bounds of the following claims.

The principle of using the source light from the image display to perform the transmissive scanning operation will be illustrated as follows in details.

First of all, according to conventional means, for example by pressing a scanning key (not shown) on the image scanning apparatus 30 or opening an image processing application program, a transmissive scanning operation is initiated.

In the embodiment of FIG. 3, the host computer 300 contains therein a control program for controlling the illuminating statuses of the image display 40. For example, the control program can be built in the common TWAIN driver of the image scanning apparatus 30. After the scanning operation is initiated, depending on the type of the image sensor used in the image scanning module 32 such as a charge couple device (CCD) or contact image sensor (CIS), the image display 40 emits light controllable by the control program. The light emitted from the image display 40 will penetrate through the light diffusing plate 42 and the film, and then be received by the image scanning module 32, thereby generating an image signal of the film.

Moreover, the principle of using the source light from the image display to perform the transmissive scanning operation will also be illustrated as follows in more details.

Various image scanning modules known to those skilled in the art, including for example one or three-line contact image sensor (CIS) or one or three-line charge couple device (CCD), can be used in the image scanning apparatus of the present invention. An example of the image display for use in the present invention includes a cathode ray tube (CRT), a liquid crystal display (LCD), a plasma display, an organic light-emitting diode (OLED) display, and the like. The source light illuminated by these image displays is composed of three colors, i.e. red, blue and green colors. By mean of the control program, the illuminating statuses of the image display are controllable.

For example, in a case that a one-line CIS sensor and a liquid crystal display are utilized, three-pass scan is required for the one-line CIS sensor. During the scanning period, the control program will control the image display to successively emit red, blue and green lights to be sensed by the one-line CIS sensor.

On the other hand, in a case that a three-line CIS sensor or three-line CCD sensor and a liquid crystal display are utilized, one-pass scan is required for the three-line CIS or CCD sensor. During the scanning period, the control program will control the image display to simultaneously emit red, blue and green lights, which are combined as a white light, to be sensed by the three-line CIS sensor.

The above examples are applied to color scanning. In contrast, in a case that a monochromatic or grey scanning operation is performed, a monochromatic light (for example a green light) emitted the image display 40 is satisfied.

The principle of performing color scanning, grey scanning, grey scanning, monochromatic scanning, one-pass scanning or three-pass scanning operation is known to those skilled in the art, and needs not be redundantly described herein.

Referring to FIG. 4, another embodiment of the present invention is illustrated. The embodiment of FIG. 4 illustrates an image display 50, an image scanning apparatus 60, a connection member 61, an image scanning module 62 and a control circuit 63. There are some differences between the embodiments of FIG. 3 and FIG. 4. For example, in the embodiment of FIG. 3, the image scanning apparatus 30 is electrically connected to the host computer 300, and the image display 40 is controllable by the control program built in the host computer 300. Whereas, the in the embodiment of FIG. 4, the image scanning apparatus 60 is not linked to the host computer. Instead, the control circuit 63 within the image scanning apparatus 60 is employed to control the image display 50. The principle of controlling the image display is known to those skilled in the art, and needs not be redundantly described herein.

From the above description, it is understood that the image scanning apparatus of the present invention is capable of performing a transmissive scanning operation by using the light source of an image display. In addition, by using the light source of an image display, the reflective scanner, which is typically used for scanning opaque objects, can also perform the transmissive scanning operation without additional penetrative light source. Furthermore, since no additional space is required for accommodating the scanning apparatus of the present invention and the scanning apparatus can be hanged on the image display when used, the space for operating this scanning apparatus is largely reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image scanning apparatus for scanning a transparent object by using a source light generated from an image display, said image scanning apparatus comprising: p1 a housing;
an image scanning module disposed within said housing for scanning said object, thereby generating an electrical signal of an image of said object; and
a connection member for hanging said housing on said image display such that said image scanning module receives said source light from said image display.

2. The image scanning apparatus according to claim 1 further comprising a light diffusing plate arranged between said image display and said object, thereby achieving even illumination of said source light for penetrating through said object.

3. The image scanning apparatus according to claim 1 wherein said connection member includes two hook structures.

4. An image scanning system for scanning an object, comprising:
an image display for generating a source light for scanning said object;
a host computer in communication with said image display; and
an image scanning apparatus in communication with said host computer, and comprising:
a housing;
an image scanning module disposed within said housing for scanning said object, thereby generating an electrical signal of an image of said object; and
a connection member for hanging said housing on said image display such that said image scanning module receives said source light from said image display.

5. An image scanning apparatus for scanning a transparent object by using a source light generated from an image display, said image scanning apparatus comprising:
a housing;
an image scanning module disposed within said housing for scanning said object, thereby generating an electrical signal of an image of said object; and
a control circuit disposed within said housing for controlling said image scanning module and said image display, characterized in that said image display is controlled to generate said source light by said control circuit.
